(19) United States
(12) Patent Application Publication
(10) Pub. No.: US 2013/0055935 A1
(43) Pub. Date: Mar. 7, 2013

(54) BIOMASS PULVERIZING APPARATUS AND BIOMASS/COAL MIXED-COMBUSTION SYSTEM

(71) Applicants: Kazuhiro Takeuchi, Minato-ku (JP); Takuichiro Daimaru, Minato-ku (JP); Masaaki Kinoshita, Minato-ku (JP); Yoshiki Yamaguchi, Minato-ku (JP); Norichika Kai, Nagasaki-shi (JP)

(72) Inventors: Kazuhiro Takeuchi, Minato-ku (JP); Takuichiro Daimaru, Minato-ku (JP); Masaaki Kinoshita, Minato-ku (JP); Yoshiki Yamaguchi, Minato-ku (JP); Norichika Kai, Nagasaki-shi (JP)

(21) Appl. No.: 13/697,618

(22) PCT Filed: May 12, 2011
(86) PCT No.: PCT/JP2011/060997

§ 371 Date: Nov. 13, 2012

(30) Foreign Application Priority Data
May 14, 2010 (JP) 2010-112464

(51) Int. Cl. B02C 15/00; F23K 1/00; B02C 23/24

(52) U.S. Cl. 110/232; 241/47

(57) ABSTRACT

A biomass pulverizing apparatus includes a pulverizing apparatus body including a feedstock supply pipe for supplying biomass feedstock from above in a vertical axial direction, a pulverizing table for placing the biomass feedstock, a drive section for rotationally driving the pulverizing table, a pulverizing roller for pulverizing the biomass feedstock by a pressing force, the pulverizing roller being operated in conjunction with the rotation of the pulverizing table, a blower means for forming an upward flow upward from below on the outer peripheral side of the pulverizing table so as to jet conveying gas for conveying the biomass powder in an air stream, and a classifier for classifying the biomass powder accompanied with the conveying gas.

### FIELD

The present invention relates to a biomass pulverizing apparatus and a biomass/coal mixed-combustion system that crush and pulverize biomass solid matter.

### BACKGROUND

In recent years, reduction of CO₂ emissions has been promoted from a viewpoint of global warming. Particularly, in combustion facilities, such as boilers for power generation, fossil fuels, such as coal and heavy fuel oil, are used as fuel in many cases. However, this fossil fuel causes global warming from the problems of CO₂ emission, and the use thereof is being regulated from the standpoint of earth environmental preservation. Further, development and practical use of energy resources that substitute for this are required also from a viewpoint of exhaustion of fossil fuels. Therefore, utilization of fuel using biomass is promoted as an alternative to fossil fuels. The biomass is organic matter resulting from photosynthesis, and there is biomass, such as woody material, plants, agricultural products, and kitchen waste. By processing this biomass as fuel, the biomass can be effectively used as an energy source or an industrial source.

Using the biomass as fuel is performed from a viewpoint of efficient utilization of the biomass that is renewable energy. As one of the methods of using the biomass as fuel, there is a method of pulverizing solid biomass matter and supplying the pulverized matter to a pulverized coal burning boiler for use as fuel. In this method, an independent pulverization type that pulverizes coal and the biomass independently, and a mixed pulverization type that performs pulverization after coal and the biomass are mixed are known. In both types, a biomass pulverizing apparatus for pulverizing solid biomass matter is required. However, in a case of attempting to use an existing mill used with the coal burning boiler of the related art, a mixed combustion rate with respect to coal remains at about 3 cal % at maximum from the capability constraints of the existing mill.

In order to pulverize the biomass of the related art to a particle diameter for the coal burning boiler, a coal pulverizer is used as it is, for example, biomass feedstock is input into a pulverizing table within a pulverizing apparatus, and is pulverized, dried, and classified by pulverizing rollers that rotate in conjunction with the pulverizing table. Then, the pulverized biomass is conveyed to the burner side in an air stream (refer to Patent Documents 1 and 2).

### CITATION LIST

### Patent Literature

Patent Literature 1: Japanese Laid-open Patent Publication No. 2004-347241

Patent Literature 2: Japanese Laid-open Patent Publication No. 2009-291692

### SUMMARY

### Technical Problem

However, in a case where woody biomass feedstock is pulverized using the coal pulverizing apparatus of the related art, there are the following problems.

1) Since the woody biomass feedstock has compressibility unlike coal, there is a problem in that pressure is not sufficiently transmitted to the biomass feedstock and pulverization is difficult in a case where the feedstock is bitten into the pulverizing rollers and the pulverizing table and is pulverized.

Further, since the biomass feedstock has high moisture content, and is fibrous, in a case where the feedstock is sandwiched between the pulverizing rollers and the pulverizing table and is pressed, the pulverized biomass powder (fine powder) is entangled with each other, and has a property of being difficult to separate.

For this reason, even if being pulverized by the coal pulverizing apparatus of the related art, the coarse particles and fine powder of the pulverized biomass powder are solidified and become difficult to move. As a result, there are problems in that excessive pulverization occurs, the pulverization processing amount of the biomass feedstock declines significantly compared to the case of coal pulverization, and the consumption power in the pulverizing apparatus increases.

Moreover, even in a case where mixed pulverization is performed with coal, if a mixed pulverization rate is generally raised with 5 to 10% up to a mixing limit of the woody biomass feedstock, there are problems in that the particle size of the fine powder declines and the combustion efficiency in the burner deteriorates.

Further, since the power of the pulverizing apparatus increases, it is necessary to lower the capacity of the pulverizing apparatus to perform operation.

2) Further, in order to perform floating combustion of the woody biomass feedstock using the coal burning boiler of the related art, it is necessary to perform pulverization such that an average particle diameter is about 0.5 to 1 mm. However, there is a problem in that, for example, pulverizing a large amount to this size, using a hammer mill or a cutter mill, is inefficient.

3) Moreover, since the woody biomass powder (coarse particles) that is not sufficiently pulverized have an irregular shape, and is apt to be entangled with each other, even if the woody biomass powder is discharged from the outer peripheral portions of the pulverizing rollers, and rises due to a jet air current provided around the pulverizing table, there are problems in that separation of the coarse particles and the fine powder is not easy, and a ratio in which pulverization is performed to exceed a particle diameter required for burning-out increases, and pulverization power increases.

Thus, unlike the pulverizing apparatus that uses the coal pulverizing apparatus of the related art, the appearance of a biomass pulverizing apparatus that can pulverize the woody biomass feedstock efficiently and stably is desired.

An object of the invention is to provide a biomass pulverizing apparatus and a biomass/coal mixed-combustion system that can pulverize biomass feedstock efficiently and stably in view of the above problems.

### Solution to Problem

According to a first aspect of the invention in order to solve the above-mentioned problems, there is provided A biomass pulverizing apparatus comprising: a pulverizing apparatus body including a feedstock supply pipe for supplying biomass feedstock from above in a vertical axial direction; a pulverizing table including a table liner for placing the biomass feedstock; a drive section for rotationally driving the pulverizing table; a pulverizing roller for pulverizing the biomass feedstock by a pressing force, the pulverizing roller being operated in conjunction with the rotation of the pulverizing table; a blower means for forming an upward flow upward from below on an outer peripheral side of the pulverizing table so as to jet conveying gas for conveying the pulverized biomass powder in an air stream; and a classifier that is provided inside a top of the pulverizing apparatus body, the classifier for classifying the biomass powder accompanied with the conveying gas, wherein a plurality of radial table grooves is formed in a surface of the table liner of the pulverizing table from an inner peripheral portion of the table liner toward an outer edge thereof, and tips of the grooves extend to a vicinity of a central portion of the table liner.

According to a second aspect of the invention, there is provided the biomass pulverizing apparatus according to the first aspect, wherein the tips of the table grooves incline toward the rotational direction of the pulverizing table.

According to a third aspect of the invention, there is provided the biomass pulverizing apparatus according to the first or second aspect, wherein the table grooves are adapted to become narrow and shallow gradually from the inner peripheral portion to the central portion.

According to a fourth aspect of the invention, there is provided the biomass pulverizing apparatus according to any one of the first to third aspects, wherein the cross-sectional shape of the table grooves is such that an inclined surface in the movement direction of the pulverizing table inclines gently and a surface facing the inclined surface is a substantially vertical surface.

According to a fifth aspect of the invention, there is provided the biomass pulverizing apparatus according to any one of the first to fourth aspects, wherein the surfaces of the pulverizing rollers are formed with radial roller grooves having tips corresponding to the table liner as base points and extending to a roller central portion, and the tables grooves and the inclination direction of the grooves are different.

According to a sixth aspect of the invention, there is provided the biomass pulverizing apparatus according to the fifth aspect, wherein the tips of the roller grooves incline toward a direction opposite to the rotational direction of the pulverizing rollers.

According to a seventh aspect of the invention, there is provided the biomass pulverizing apparatus according to the fifth aspect or the sixth aspect, wherein the roller grooves are adapted to become narrow and shallow gradually from the inner peripheral portion to the central portion.

According to a eighth aspect of the invention, there is provided the biomass pulverizing apparatus according to any one of the fifth to seventh aspect, wherein the cross-sectional shape of the roller grooves is such that an inclined surface in the rotational direction of the pulverizing rollers inclines gently and a surface facing the inclined surface is a substantially vertical surface.

According to a ninth aspect of the invention, there is provided a biomass/coal mixed-combustion system including: the biomass pulverizing apparatus according to any one of the first to eighth aspects; a coal pulverizing apparatus for pulverizing coal feedstock; and a boiler furnace to which biomass powder pulverized by the biomass pulverizing apparatus and coal powder pulverized by the coal pulverizing apparatus are supplied.

### Advantageous Effects of Invention

According to the invention, if the biomass feedstock is supplied, large particle feedstock easily enters the table grooves, and the shearing actions of the table liner and the pulverizing rollers work along with a pressing force caused by the pulverizing rollers. Thus, the biomass feedstock can be efficiently and stably pulverized.

### BRIEF DESCRIPTION OF DRAWINGS

FIG. 1 is a schematic view of a biomass pulverizing apparatus according to a first embodiment.

FIG. 2 is a cross-sectional schematic view of the biomass pulverizing apparatus according to the first embodiment.

FIG. 3-1 is a plan view of a table liner.

FIG. 3-2 is a perspective view of the table liner.

FIG. 3-3 is a partial cross-sectional view of a groove of FIG. 3-2.

FIG. 3-4 is a perspective view of another groove shape.

FIG. 4 is a schematic configuration view of a table liner and a pulverizing roller of the biomass pulverizing apparatus according to the first embodiment.

FIG. 5 is a schematic configuration view of a table liner and a pulverizing roller of a biomass pulverizing apparatus according to a second embodiment.

FIG. 6-1 is a front view of the pulverizing roller.

FIG. 6-2 is a plan view of the pulverizing roller.

FIG. 6-3 is a partial cross-sectional view of grooves of FIG. 6-2.

FIG. 7-1 is a perspective view of the groove shape of other roller grooves according to the second embodiment.

FIG. 7-2 is a perspective view of the groove shape of other roller grooves according to the second embodiment.

FIG. 8 is a schematic view of a biomass/coal mixed-combustion system including a boiler furnace according to a third embodiment.

### DESCRIPTION OF EMBODIMENTS

The invention will be described below in detail while referring to the drawings. Note that, the invention is not limited by embodiments. Further, constituent elements in the following embodiments include elements that are easily conceivable by a person skilled in the art, or substantially the same elements.

### First Embodiment

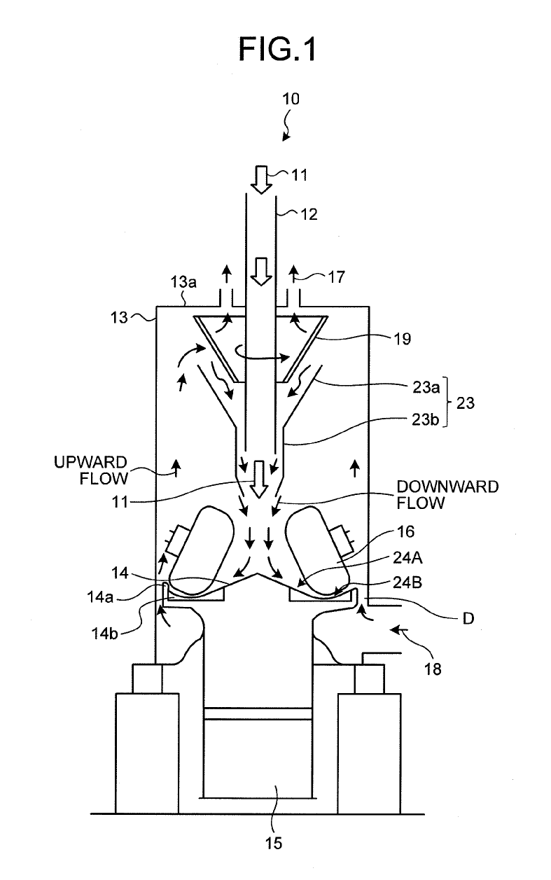

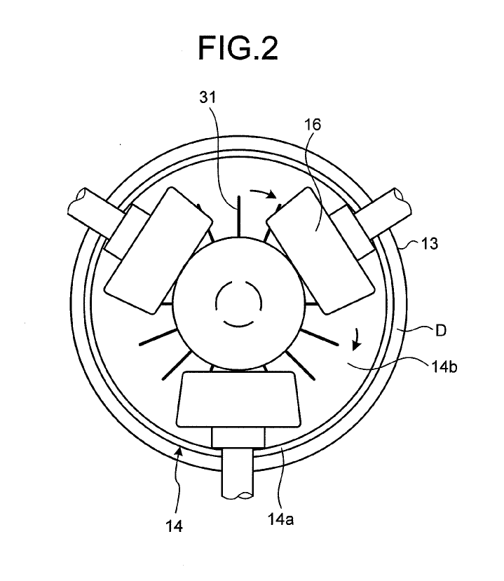

A biomass pulverizing apparatus according to a first embodiment of the invention will be described with reference to the drawings. FIG. 1 is a schematic view of the biomass pulverizing apparatus according to the present embodiment. FIG. 2 is a cross-sectional schematic view of the biomass pulverizing apparatus according to the first embodiment.

As illustrated in FIGS. 1 and 2, a biomass pulverizing apparatus 10 according to the present embodiment includes a pulverizing apparatus body 13 having a feedstock supply pipe 12 that supplies biomass feedstock 11 from above in a vertical axial direction, a pulverizing table 14 on which the supplied biomass feedstock 11 is placed, a drive section 15 that rotationally drives the pulverizing table 14, pulverizing rollers 16 that are operated in conjunction with the rotation of the pulverizing table 14 and pulverize the biomass feedstock 11 by a pressing force, blower means (not illustrated) that forms an upward flow upward from below on the outer peripheral side of the pulverizing table 14 and jets conveying gas 18 that conveys the pulverized biomass powder 17 in an air stream, and a classifier 19 that is provided inside the top of the pulverizing apparatus body 13 and classifies the biomass powder 17 accompanied with the conveying gas 18, and a plurality of radial table grooves 31 is formed in the surface of a table liner 14b of the pulverizing table 14 from the inner peripheral portion of the table liner toward the outer edge thereof, and tips 31a of the grooves extend to the vicinity of a central portion of the table liner.

The pulverizing table 14 is formed in a substantially circular trapezoidal shape, the upper surface of the pulverizing table 14 is formed in a concave shape so that the biomass solid matter placed on this table does not fall off, and a weir 14a is on the outer peripheral side of the upper surface. Further, a freely replaceable table liner 14b is provided in order to prevent wear of the pulverizing table 14.

Note that, a motor (not illustrated) is connected to a drive shaft (not illustrated) that is provided to extend from the lower side of the pulverizing table 14, and the pulverizing table 14 is rotated by the motor.

The pulverizing rollers 16 are provided above a position shifted outward from the center of the pulverizing table 14. The pulverizing rollers 16 exert a pressing force on the biomass feedstock 11 placed on the table liner 14b of the pulverizing table 14 while rotating in conjunction with the pulverizing table 14, and pulverize this biomass feedstock.

At this time, a speed reducer is connected to the motor, and a variable hydraulic power source or a spring that changes pulverization load is connected to the pulverizing rollers 16. A control can be performed by a control device (not illustrated) so that the pulverization load of the pulverizing rollers 16 is increased and decreased in a stepless fashion or in a stepwise fashion and pulverization power falls within a rated range, and preferably becomes almost constant.

The feedstock supply pipe 12 is inserted through a top plate 13a of the pulverizing apparatus body 13 in the vertical axial direction, and is installed so that the biomass feedstock 11 is dropped onto the pulverizing table 14.

The classifier 19 secondarily classifies a slightly fine powder and granular material after passing through pneumatic classification (primary classification) by conveying gas (primary air) 18, and a fixed classifier (cyclone separator) or a rotary classifier (rotary separator) is used.

In the classifier 19 of the present embodiment, a funnel-shaped classifier is used, and coarse particles and fine particles are classified by classifying vanes provided in an opening (not illustrated). The classified coarse particles fall to the pulverizing table 14 side where pulverization is performed again.

The blower means that supplies the conveying gas (primary air) 18 supplies primary air with a predetermined flow rate and a predetermined temperature into the apparatus body 13 from the periphery of the pulverizing table 14, and a damper or the like is used for adjustment of an air flow rate. Further, temperature control means is provided if needed. The air flow rate or temperature is appropriately controlled by the control device (not illustrated).

A gap D is provided between the outer peripheral edge of the pulverizing table 14 and the inner peripheral surface of the apparatus body 13, and the conveying gas (primary air) 18 supplied from the blower means blows to the upper side of the pulverizing table 14 via the gap D. Note that, drift vanes (not illustrated) may be provided in the gap D. The drift vanes adjust the direction of the blowdown of the primary air, and the angle of the drift vanes may be controlled arbitrarily.

A funnel-shaped rectifying member 23 with the same shape as the classifier 19 is fixed at a predetermined interval from the classifier 19 on the side of an upper portion of the apparatus body 13 and is provided to extend downward. The funnel-shaped rectifying member 23 drops the biomass powder (coarse particles) classified by the classifier 19 to the pulverizing table 14 again. The funnel-shaped rectifying member 23 is formed from a funnel portion 23a that receives the classified biomass powder (coarse particles) that is expanded and contracted from an upper portion of the rectifying member toward a lower portion thereof, and a tubular portion 23b that has a predetermined interval from the feedstock supply pipe 12 and drops the biomass powder (coarse particles).

Note that, a lower end portion of the tubular portion 23b of the funnel-shaped rectifying member 23 is reduced in diameter and prevents diffusion of the biomass powder (coarse particles) that is classified and falls.

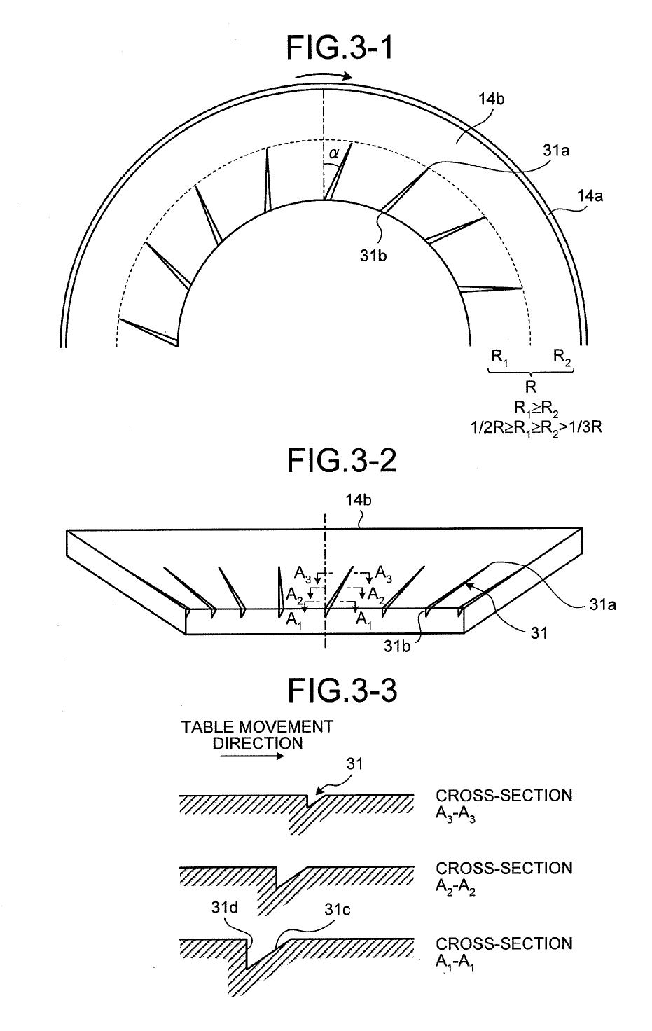

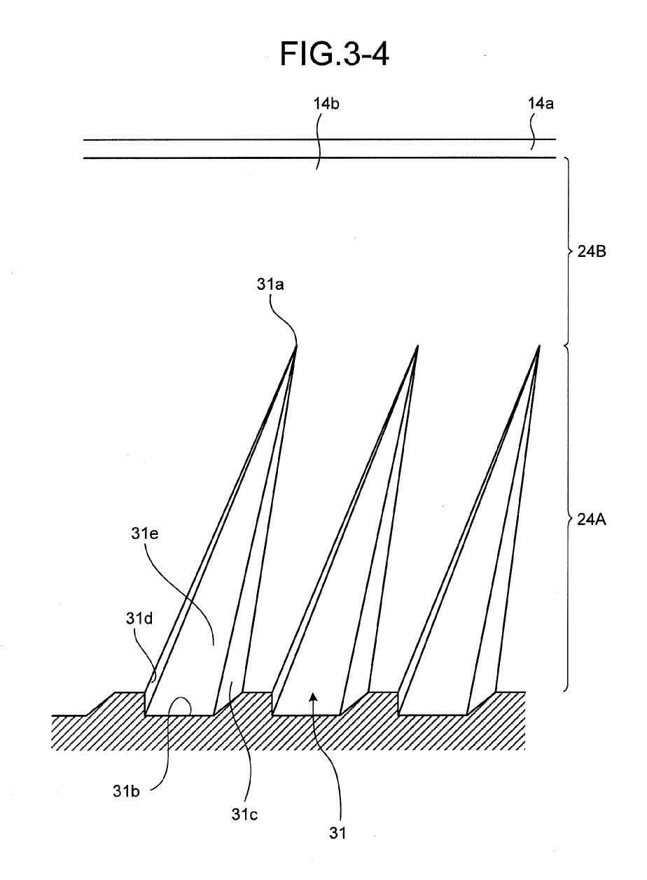

FIGS. 3-1 to 3-4 are conceptual views illustrating an embodiment of table grooves, FIG. 3-1 is a plan view of the table liner, FIG. 3-2 is the perspective view of the table liner, and FIG. 3-3 is a partial cross-sectional view of a groove of FIG. 3-2. FIG. 3-4 is a perspective view of another groove shape. FIG. 4 is a schematic configuration view of a table liner and a pulverizing roller of the biomass pulverizing apparatus according to the present embodiment.

As illustrated in FIGS. 3-1 to 3-3, and 4, in the present embodiment, radial table grooves 31 are formed in the surface of the table liner 14b of the pulverizing table 14 from an inner peripheral portion of the table liner to a central portion thereof.

For this reason, if the biomass feedstock 11 is supplied, large particle feedstock easily enters the table grooves 31 from groove base points 31b at the inner peripheral portion of the table liner 14b to groove central portions, and the shearing actions of both the table liner and the pulverizing rollers work along with a pressing force caused by the pulverizing rollers 16. As a result, pulverization becomes good.

Although the table grooves 31, as illustrated in FIG. 3-1, extend toward a weir 14a of an outer edge portion of the table liner 14b on the upper surface of the table liner 14b, the tips 31a of the table grooves 31 extend to the central portion of the table liner 14b.

By forming the table grooves 31 from the groove base points 31b to the central portion in the middle of the table liner 14b for the tips 31a, a groove forming portion forms a rough pulverization region 24A, and a planar portion where no groove is formed forms a fine pulverization region 24B. As a result, fine pulverization of the biomass is ensured by sufficiently securing the fine pulverization region compared to a case where grooves are formed over the whole surface.

Further, as illustrated in FIG. 3-1, it is preferable that the relationship between the formation distance R₁ of the grooves that settles the pulverization regions and the distance R₂ over which no groove is formed be set to the following relationship in a case where the radial length of the table liner 14b is R. However, the relationship may vary depending on the biomass properties.

1/2R≧R₁≧R₂>1/3R

Further, as illustrated in FIGS. 3-2 and 3-3, the table grooves 31 are adapted to gradually become narrow and shallow in cut depth from the groove base points (inner peripheral portion) 31b to the tips (outer peripheral portion) 31a.

In FIGS. 3-2 and 3-3, the groove at cross-section A₁-A₁ is where the groove is deepest and widest, the groove at cross-section A₂-A₂ is where the groove has a medium depth and width, and the groove at cross-section A₃-A₃ is where the groove is shallowest and narrowest.

Further, as illustrated in FIG. 3-1, it is more preferable that the table grooves 31 that extend radially incline gently in the rotational direction of the table at an inclination angle a with respect to the radial line of the table.

Further, as illustrated in FIG. 3-3, the shape of the table grooves 31 is a shape near a substantially right-angled triangle with respect to the table surface such that a groove surface 31c in a table movement direction inclines gently and a groove surface 31d on the opposite side inclines as a substantially vertical surface.

As a result, as illustrated in FIG. 4, favorable shearing of the biomass feedstock 11 when being pressed by the pulverizing rollers 16 is made.

Moreover, as illustrated in FIG. 3-4, in addition to the substantially right-angled triangle, the cross-sectional shape of the table grooves 31 may be such that the cross-sectional shape of a groove is not V-shaped on the groove base point 31b side, but a groove bottom portion 31e is provided to increase the reception tolerance of the groove so as to allow pulverization of a larger biomass feedstock 11.

### Second Embodiment

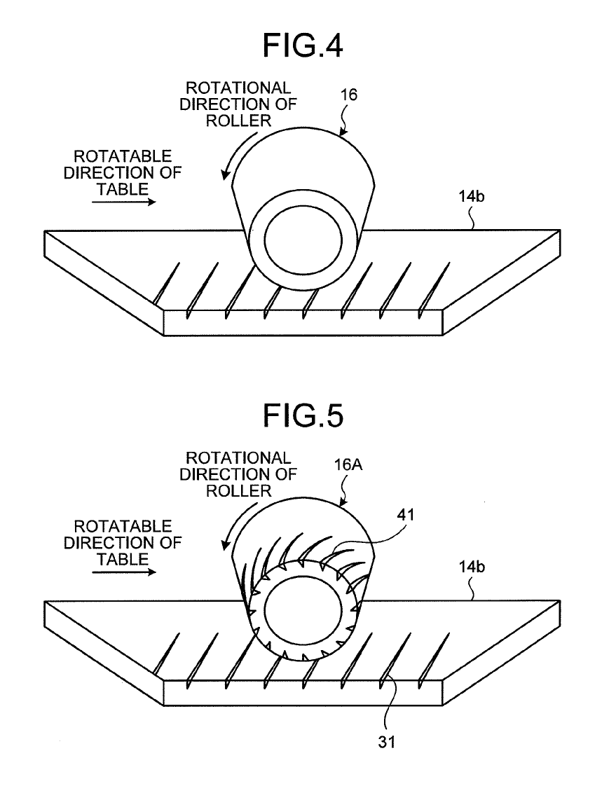

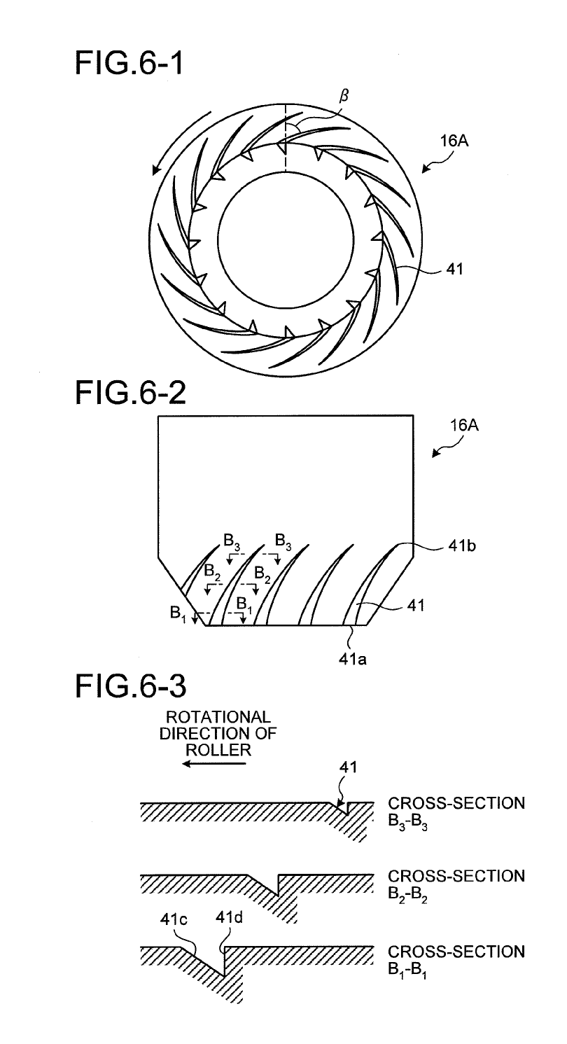

A biomass pulverizing apparatus according to a second embodiment of the invention will be described with reference to the drawings. FIG. 5 is a schematic configuration view of a table liner and a pulverizing roller of the biomass pulverizing apparatus according to the present embodiment. FIGS. 6-1 to 6-3 are conceptual views illustrating an example of roller grooves, FIG. 6-1 is a front view of the pulverizing roller, FIG. 6-2 is a plan view of the pulverizing roller, and FIG. 6-3 is a partial cross-sectional view of a groove of FIG. 6-2.

As illustrated in FIGS. 5 and 6-1 to 6-3, a pulverizing roller 16A applied to the biomass pulverizing apparatus according to the present embodiment has a plurality of roller grooves 41 formed in the external surface thereof.

In the roller groove 41, the end of a roller small-diameter portion corresponding to the inner peripheral surface of the table liner 14b is a base point 41a, and a tip 41b of the groove extends to the vicinity of the central portion of the roller.

Further, as illustrated in FIGS. 6-2 and 6-3, the roller grooves 41 are adapted to become narrow and shallow in cut depth gradually from the base points (inner peripheral portion) 41a to the tips (outer peripheral portion) 41b.

In FIGS. 6-2 and 6-3, the groove at cross-section B₁-B₁ is where the groove is the deepest and widest, the groove at cross-section B₂-B₂ is where the groove has a medium depth and width, and the groove at cross-section B₃-B₃ is where the groove is the shallowest and narrowest.

Note that, the width and depth of the roller grooves 41 on the inlet side may be changed depending on the size of feedstock.

The number and length of the grooves may be appropriately changed depending on the difficulty of cutting of feedstock, or the like. Further, the shape of the grooves can be changed depending on the shape, dimensions, and material kind of the pulverizing roller 16A.

Further, as illustrated in FIG. 6-1, it is more preferable that the roller grooves 41 that extend radially incline in a direction different from the rotational direction of the pulverizing rollers 16 at an inclination angle β with respect to the radial line of the roller. Further, since the shearing force is improved as the inclination angle β is larger than the inclination angle a of the table liner 14b, this is preferable.

Further, the shape of the roller grooves 41, as illustrated in FIG. 6-3, is made different from the groove shape of the table liner 14b.

That is, a gently inclined surface 41c is provided in the biting direction of the biomass feedstock and the surface on the opposite side is used as a substantially vertical 41d.

Thereby, the inclined surface 41c promotes the cut feedstock moving to the outer peripheral side of the table. Note that, the inclination angle of the grooves can be changed depending on material kind and property.

In the present invention, since the outer peripheral portion of the table has a smooth structure so that cutting is performed by a shearing action caused by the grooves in the rough pulverization region 24A (inner peripheral portion) of the pulverizing table 14, and then, pulverization can be performed by the compressive force of the pulverizing rollers 16 and the table liner 14b, an efficient force works during the fine pulverization of the biomass. Therefore, the tissue of the woody biomass is divided.

Pulverization in such a biomass pulverizing apparatus in which the table grooves 31 are formed in the table liner 14b of the pulverizing table 14 and the roller grooves 41 are formed on the pulverizing rollers 16 side will be described.

First, the supplied biomass feedstock 11 is input into the central portion of the pulverizing table 14.

A rough flow that is separated by the classifier 19 and needs to be further atomized are intermingled in the biomass feedstock 11.

The feedstock moves to the table due to centrifugal force caused by the rotation of the table, and a large feedstock enters the table grooves 31 formed in the table liner 14b.

Further, in the roller grooves 41 formed in the outer peripheral surfaces of the pulverizing rollers 16, large particles pinched by the groove portions of the table grooves 31 move to the outer peripheral portion while being bitten and sheared between acute surfaces of the grooves of both the table liner and the pulverizing rollers.

Since the biomass feedstock 11 is made into fine particles as it moves to the outer peripheral portion, the groove width and the depth of the table grooves 31 and the roller grooves 41 are gradually decreased to promote pulverization.

The woody biomass divided into coarse powder in the coarse particles pulverization region 24A moves to the downstream side (outer peripheral portion of the mill) of the fine pulverization region 24B. In this portion, no groove is formed in the pulverizing rollers 16 and the table liner 14b, and the gap is set to be small between both the pulverizing rollers and the table liner. Thereby, a compressive force is generated in the bitten feedstock, and fine pulverization to a desired particle diameter is made.

FIGS. 7-1 and 7-2 are perspective views of the groove shape of other roller grooves according to the present embodiment.

As illustrated in FIGS. 7-1 and 7-2, in addition to the substantially right-angled triangle, the cross-sectional shape of the roller grooves 41 may be such that the cross-sectional shape of a groove is not V-shaped on a base point 41a side, but a groove bottom portion 41e is provided to increase the reception tolerance of the groove so as to allow pulverization of a larger biomass feedstock 11.

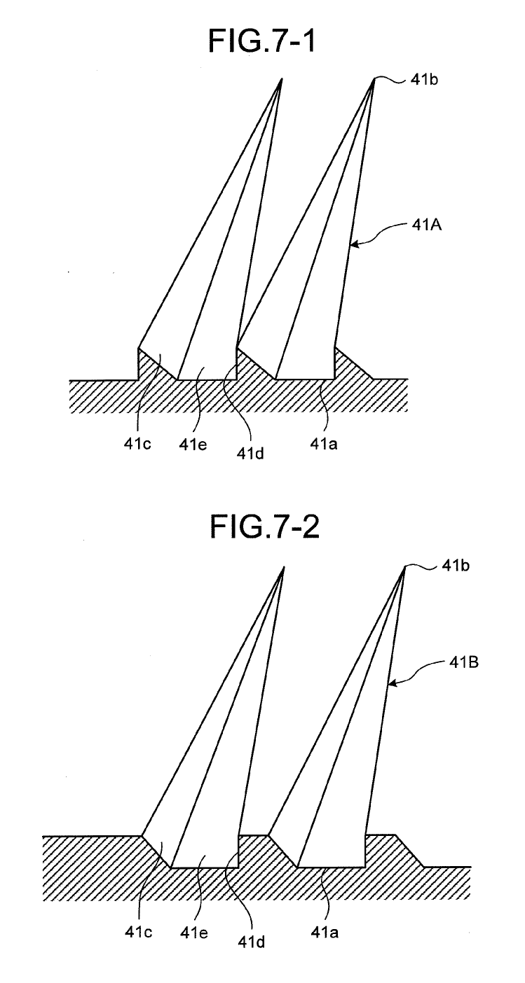

Here, groove pitch is made small in the roller grooves 41A illustrated in FIG. 7-1, and the width of groove pitch is made large in the roller grooves 41B illustrated in FIG. 7-2.

As a result, favorable shearing of the biomass feedstock 11 when the pulverizing rollers 16 press the table liner 14b of the pulverizing table 14 is made.

The woody biomass has compressibility, and contains a lot of moisture, and the pulverization capability is remarkably lowered in an ordinary coal mill. As in the invention, the table grooves 31 are formed in the inner peripheral portion of the table liner 14b, the roller grooves 41 are formed on the tip side of the outer peripheries of the pulverizing rollers 16, and the width and depth of the grooves are gradually narrowed. Thus, a large size of feedstock of the introduced woody biomass moves to the outer peripheral portion and is pulverized at the outer a peripheral portion, while being caught by the grooves and cut and made into fine particles by the acute end portions of the groove portions of the table liner 14b and the pulverizing rollers 16.

As a result, the woody biomass can be more efficiently pulverized.

### Third Embodiment

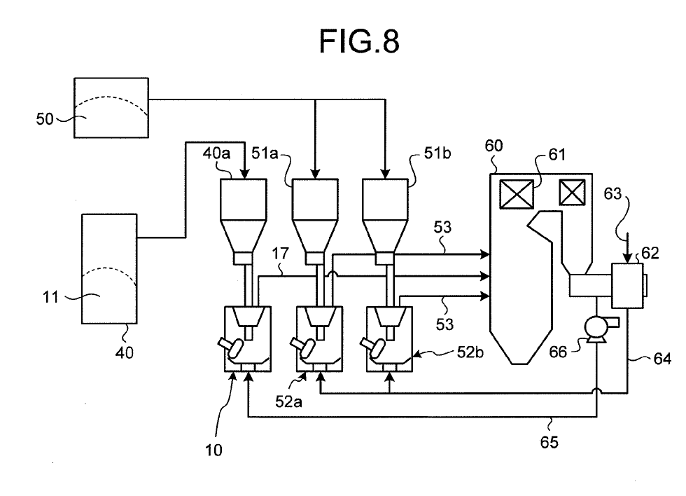

A biomass/coal mixed-combustion system including a boiler furnace according to a third embodiment of the invention will be described with reference to the drawing. FIG. 8 is a schematic view of a biomass/coal mixed-combustion system including a boiler furnace according to the present embodiment.

As illustrated in FIG. 8, the above-described biomass pulverizing apparatus 10 is applied to the biomass/coal mixed-combustion system including a boiler furnace according to the present embodiment. As illustrated in FIG. 8, the biomass/coal mixed-combustion system according to the present embodiment includes a biomass storage facility 40 in which the biomass feedstock 11 that is primarily pulverized (coarsely crushed) and dried to a predetermined particle diameter or less if necessary is stored, the biomass pulverizing apparatus 10 including a hopper 40a to which the biomass feedstock 11 is supplied, coal pulverizing apparatuses 52a and 52b including hoppers 51a and 51b that receive coal 50, and a boiler furnace 60 to which the biomass powder 17 obtained by the biomass pulverizing apparatus 10 and the coal powder 53 obtained by the coal pulverizing apparatuses 52a and 52b are supplied.

The biomass feedstock 11, such as wood waste, is sorted to a certain size, stored in the biomass storage facility 40 as biomass chips, and then supplied to the biomass hopper 40a. The biomass chips are supplied to the biomass pulverizing apparatus 10 from the biomass hopper 40a and are pulverized by the pulverizing table 14 and the pulverizing rollers 16. Biomass pulverized matter and coal pulverized matter after pulverization are supplied to the boiler furnace 60, and biomass powder and coal powder are mixed and combusted within the boiler furnace 60.

A fuel supply nozzle and a burner that operates with this nozzle are disposed in a furnace body of the boiler furnace 60. The combustion exhaust gas generated by combustion heats a heat-transfer tube 61 disposed within the furnace, and is sent to a flue. An air heater (AH) 62 is provided in the middle of the flue provided in a furnace outlet of the furnace body, and the combustion exhaust gas that has passed through the air heater 62 is discharged to the atmosphere through an exhaust gas treatment facility (not illustrated), such as an ash trapping device.

High-temperature air 64 generated by heated ambient air 63 using the air heater 62 is supplied to the coal pulverizing apparatuses 52a and 52b and is used for drying of coal. Further, a portion of a combustion exhaust gas 65 is supplied to the biomass pulverizing apparatus 10A (10B, 10C) by an induction fan 66 and is used for classification or drying of the biomass.

By providing the system including the biomass pulverizing apparatus according to the invention in this way, biomass pulverization becomes good. Thus, stable combustion is possible without lowering combustion performance when pulverized matter is directly introduced into a combustion device.

Further, since the total amount of the blowing gas does not change compared to the related art, it is possible to stably operate the biomass pulverizing apparatus within a range of the amount of air required for a combustion facility without a change in the primary air.

### REFERENCE SIGNS LIST

10 Biomass pulverizing apparatus

11 Biomass feedstock

12 Feedstock supply pipe

13 Pulverizing apparatus body

14 Pulverizing table

15 Drive section

16 Pulverizing roller

17 Biomass powder

18 Conveying gas

19 Classifier

31 Table groove

41 Roller groove

1. A biomass pulverizing apparatus comprising:
a pulverizing apparatus body including a feedstock supply pipe for supplying biomass feedstock from above in a vertical axial direction;
a pulverizing table including a table liner for placing the biomass feedstock;
a drive section for rotationally driving the pulverizing table;
a pulverizing roller for pulverizing the biomass feedstock by a pressing force, the pulverizing roller being operated in conjunction with the rotation of the pulverizing table;
a blower means for forming an upward flow upward from below on an outer peripheral side of the pulverizing table so as to jet conveying gas for conveying the pulverized biomass powder in an air stream; and
a classifier that is provided inside a top of the pulverizing apparatus body, the classifier for classifying the biomass powder accompanied with the conveying gas,
wherein a plurality of radial table grooves is formed in a surface of the table liner of the pulverizing table from an inner peripheral portion of the table liner toward an outer edge thereof, and tips of the grooves extend to a vicinity of a central portion of the table liner.

2. The biomass pulverizing apparatus according to claim 1,
wherein the tips of the table grooves incline toward a rotational direction of the pulverizing table.

3. The biomass pulverizing apparatus according to claim 1,
wherein the table grooves are adapted to become narrow and shallow gradually from the inner peripheral portion to the central portion.

4. The biomass pulverizing apparatus according to claim 1,
wherein the cross-sectional shape of the table grooves is such that an inclined surface in a movement direction of the pulverizing table inclines gently and a surface facing the inclined surface is a substantially vertical surface.

5. The biomass pulverizing apparatus according to claim 1,
wherein a surface of the pulverizing roller are formed with radial roller grooves having tips corresponding to the table liner as base points and extending to a roller central portion, and the tables grooves and the inclination direction of the grooves are different.

6. The biomass pulverizing apparatus according to claim 5,
wherein the tips of the roller grooves incline toward a direction opposite to the rotational direction of the pulverizing roller.

7. The biomass pulverizing apparatus according to claim 5,
wherein the roller grooves are adapted to become narrow and shallow gradually from the inner peripheral portion to the central portion.

8. The biomass pulverizing apparatus according to claim 5,
wherein the cross-sectional shape of the roller grooves is such that an inclined surface in the rotational direction of the pulverizing roller inclines gently and a surface facing the inclined surface is a substantially vertical surface.

9. A biomass/coal mixed-combustion system comprising:
the biomass pulverizing apparatus according to claim 1;
a coal pulverizing apparatus for pulverizing coal feedstock; and
a boiler furnace to which biomass powder pulverized by the biomass pulverizing apparatus and coal powder pulverized by the coal pulverizing apparatus are supplied.
